(19) United States
(12) Patent Application Publication
(10) Pub. No.: US 2024/0330864 A1
(43) Pub. Date: Oct. 3, 2024

(54) Automated Onboarding Method

(71) Applicant: Financial AI Corp., Alpharetta, GA (US)

(72) Inventor: Christopher Hoffman, Alpharetta, GA (US)

(73) Assignee: Financial AI Corp., Alpharetta, GA (US)

(21) Appl. No.: 18/610,457

(22) Filed: Mar. 20, 2024

Related U.S. Application Data
(60) Provisional application No. 63/455,759, filed on Mar. 30, 2023.

(51) Int. Cl. G06Q 10/1053; H04L 9/40

(52) U.S. Cl. CPC G06Q 10/1053; H04L 63/083

(57) ABSTRACT

An automated onboarding method provides a form which a prospective client fills out, preferably electronically, which is received by a customer relations management (CRM) software. The CRM software assigns a customer account number and populates the CRM account with the information from the form in an automated manner. At least one document is generated, preferably automatedly and sent to the potential customer to execute. When received the system may automatedly complete the onboarding process, possibly including sending an account transfer or funding form signed by the potential client to a third party for execution and updating to establish the account when funded, potentially with no human interaction during the process, or if interaction, only for authentication of the legitimacy of the applicants.

### CLAIM OF PRIORITY

This application claims the benefit of U.S. Provisional Patent Application No. 63/455,759 filed Mar. 30, 2023, which is incorporated herein by reference in its entirety.

### FIELD OF THE INVENTION

The present invention relates to an automated system to onboard new clients for various companies, such as insurance companies, brokerage accounts, banking accounts or others.

### BACKGROUND OF THE INVENTION

Many industries struggle with the process of completing the necessary paperwork required by a company and/or industry to open new accounts. Human operators must often obtain and enter information into forms, which are then sent to customers for the customers to sign and return.

These human operators add overhead to the cost of conducting business, as well as provide a potential to make mistakes or fail to complete tasks, thereby degrading the quality of the service provided by the company, such as by inputting errors and/or creating delay in the onboarding process. Those familiar with administrative burdens of generating forms to onboard new clients understand that forms are normally filled out by the company with specific information and then sent by a person to the prospective client for execution, and then on to other parties as necessary once executed. A checklist is usually employed to make sure that steps are not missed.

Accordingly, a need to exists to more efficiently and/or effectively onboard new clients for various companies.

### SUMMARY OF THE INVENTION

It is a present object of many embodiments of the present invention to automate the onboarding process more effectively than prior art attempts.

It is another object of many embodiments of the present invention to remove human interaction by a company from the onboarding process.

It is another object of many embodiments of the present invention to increase the efficiency and/or accuracy of information used to onboard new clients for a company.

Accordingly, in accordance with a presently preferred embodiment of the present invention, a digital form is provided to a potential customer. The form may be available on a website of the company or may be sent or otherwise accessed via a text, email message, or otherwise made available to a potential customer.

For at least one embodiment of the present invention a form is built such as through FormRouter™ to provide the form which receives digital information. Depending on the form utilized some portions of that form may be auto-filled based on information entered at other portions of the form. The form may be filled out by the potential client for at least some embodiments, or the form may be filled out on behalf of the potential client by another, such as an employee of the company, or other party.

For brokerage accounts, name, social security number, address, telephone number, net worth, and possible current brokerage account information, possibly including brokerage account numbers, account types, etc. may be entered into the form. A computer, or processor (smart phone, tablet, etc,) on the potential client side may complete at least enough of the information requested to process the form and send the information through the world wide web or otherwise to a computer or processor working on behalf of the company.

The digital form is preferably directed into SalesForce™, or other cooperating customer relationship management (CRM) software, either locally or remotely from the potential customer through the company's account and one or more computers. SalesForce may implement a flow chart/decision matrix based on the information provided on the form. Depending on the perceived needs of the potential client, and/or other factors, the flow chart may assign account numbers and types automatedly (without human intervention) generated for the potential client by the software and assigned to the potential client, by the computer, possibly using the CRM software so that the potential client may be input and tracked by the computer/company.

Salesforce, or other CRM, through the applicant's account may use the information from the digital form at the applicant's computer and/or remotely, to automatedly populate at least some of (a) transfer form to transfer funds from a competitor account to an account managed by the company, (b) intake forms (such as a brokerage agreement, insurance agreement, new client agreement, etc.), and/or (c) an application from (such as to establish specific new accounts at a brokerage, insurance agency, or other company). With the appropriate forms generated (any combination of (a)-(c) individually, subset thereof, or collectively, as determined by the flow chart/decision matrix), they may, for at least some embodiments, be sent automatedly (without human intervention) to the potential client for execution, possibly through a document signing service, such as DocuSign, or other company, so that the potential client may electronically, or otherwise sign, and return the executed document(s) back to the company.

If not done earlier, a human preferably reviews documents, such as the signed documents, or other documents, to ensure the potential client is a client worthy of the applicant/company's services before completing the process, or it may be only digital forms are released to client-worthy potential clients, in various embodiments.

With executed documents, the accounts may be populated, i.e., funded, and the insurance and/or brokerage account (or other account), with the new client (formerly the potential client), is now successfully onboarded for the company to begin work.

For at least some embodiments, a potential client may be onboarded as a client with an account in an automated fashion without human intervention between the step of having the potential client provide specific information, preferably in a digital format, which can be evaluated by a decision matrix/flow chart/artificial intelligence engine of a computing device to then output specific automatedly generated intake, application, and/or transfer forms and/or authorizations to be sent to the client for execution, executed and returned to the company (or sent to other organizations) to establish the agent and/or brokerage relationship with accounts having been populated, i.e., funded, as desired by the new client, without any human intervention, possibly for many embodiments, other than approval, by the applicant for at least some embodiments.

Some embodiments may have a human operator review at least some of the information provided by a potential client to make sure the flow chart/decision matrix is being properly executed, i.e., fictitious persons are not assigned accounts, if possible, or other issues addressed, and/or stop efforts at perpetuating a fraud on the company or applicant.

In addition to brokerage accounts, insurance needs, banking needs, legal needs, or other goods/service related industries may benefit from using the methodology taught herein.

### BRIEF DESCRIPTION OF THE DRAWINGS

The particular features and advantages of the inventions with other objects will become apparent from the following description taken in connection with the accompanying drawings in which:

FIG. 1 is a schematic representation of a presently preferred embodiment of the present invention at an early step with the potential client electronically populating a form;

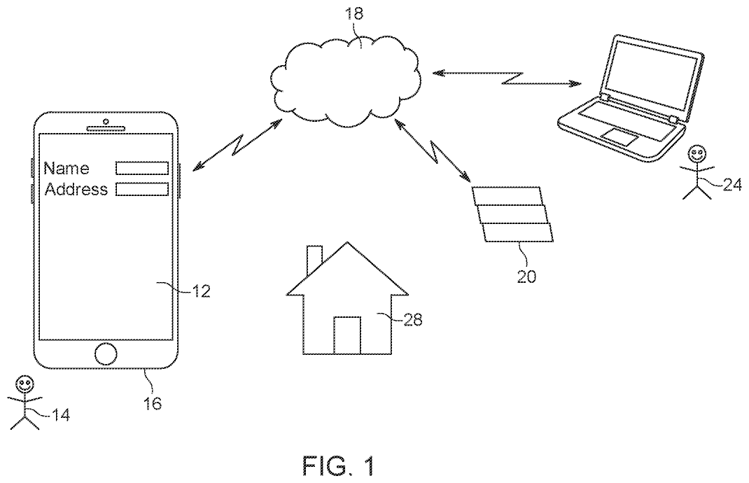

FIG. 2 is a schematic representation of a presently preferred embodiment of the present invention at a subsequent step showing a document to be signed by the potential client;

FIG. 3 is a flow chart showing a method of operation of the presently preferred embodiment of the present invention; and

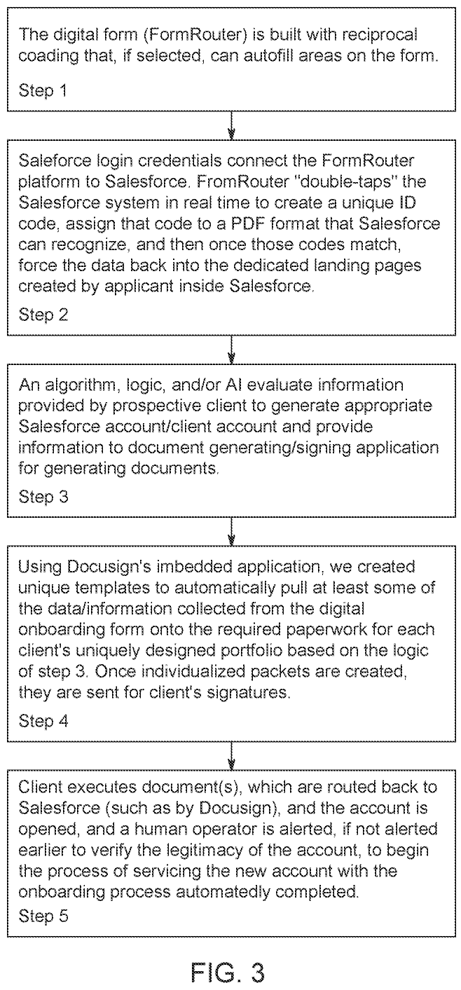

FIG. 4 is a flow chart showing the method of operation of the presently preferred method.

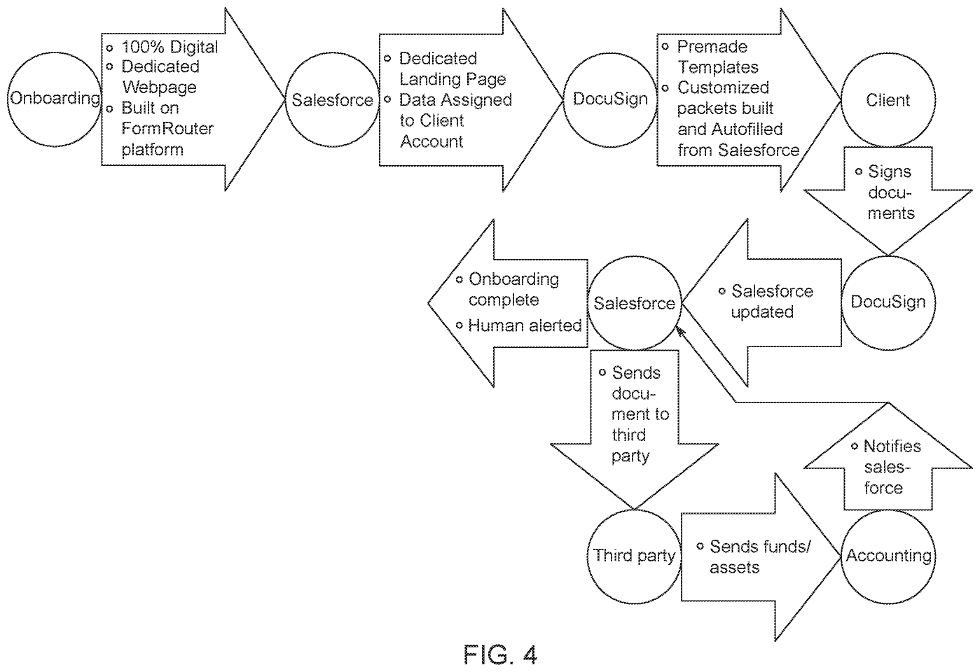

### DETAILED DESCRIPTION OF THE PREFERRED EMBODIMENT

In accordance with a presently preferred embodiment of the present invention, a digital form 12 is preferably provided to a potential customer 14. The form 12 may be available on a website of the company or may be sent or otherwise accessed via a text, email message, or otherwise made available to a potential customer 14. Other embodiments may extract digital information written, typed or otherwise provided on a form as is known in the art.

For at least one embodiment of the present invention a form 12 is built such as through FormRouter™ to provide the form 12 which receives digital information. Depending on the form utilized some portions of that form 12 may be auto-filled based on information entered at other portions of the form 12. The form 12 may be filled out by the potential client 14 for at least some embodiments, or the form 12 may be filled out on behalf of the potential client 14 by another, such as an employee of the company, or other party.

For brokerage accounts, name, social security number, address, telephone number, net worth, and possible current brokerage account information, possibly including brokerage account numbers, account types, etc. may be entered into the form 12. A computer, or other processor 16 (smart phone, tablet, etc,) on the potential client side may complete at least enough of the information requested to process the form 12 and send the information through the world wide web 18 or otherwise to one or more computers or processors 20 working on behalf of the company.

The digital form 12 is preferably directed into SalesForce™, or other cooperating customer relationship management (CRM) software, either locally or remotely from the potential customer 14 through the company's account and one or more computers 20. SalesForce may implement a flow chart/decision matrix based on the information provided on the form 12. Depending on the perceived needs of the potential client 14, and/or other factors, the algorithm may assign account numbers and types automatedly (without human intervention) generated for the potential client 14 by the software and assigned to the potential client 14, by the computer 20, possibly using the CRM software so that the potential client 14 may be input and tracked by the computer/company 20.

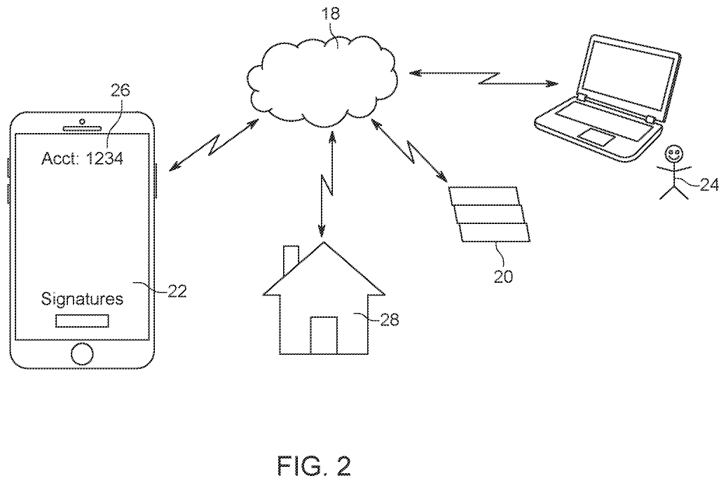

Salesforce, or other CRM, through the applicant's account may use the information from the digital form 12 at the applicant's computer 16 and/or remotely, to automatedly populate at least some of (a) transfer form to transfer funds from a competitor account to an account managed by the company, (b) intake forms (such as a brokerage agreement, insurance agreement, new client agreement, etc.), and/or (c) an application from (such as to establish specific new accounts at a brokerage, insurance agency, or other company). With the appropriate documents 22 of FIG. 2 generated (any combination of (a)-(c) individually, subset thereof, or collectively, as determined by the flow chart/decision matrix), they may, for at least some embodiments, be sent automatedly (without human intervention) to the potential client 14 for execution, possibly through a document signing service, such as DocuSign, or other company, so that the potential client may electronically, or otherwise sign, and return the executed document(s) 22 back to the company 14.

If not done earlier, a human preferably or possibly reviews documents, such as the signed documents, or other documents, to ensure the potential client is a client worthy of the applicant/company's services before completing the process, or it may be only digital documents 22 are released to client-worthy potential clients 14, in various embodiments.

With executed documents 22, the accounts may be populated, i.e., funded, and the insurance and/or brokerage account (or other account), with the new client (formerly the potential client 14), is now successfully onboarded for the company to begin work.

For at least some embodiments, a potential client 14 may be onboarded as a client with an account in an automated fashion without human intervention between the step of having the potential client 14 provide specific information, preferably in a digital format, which can be evaluated by a decision matrix/flow chart/artificial intelligence engine of a computing device 20 to then output specific automatedly generated intake, application, and/or transfer forms 22 and/or authorizations to be sent to the client for execution, executed and returned to the company (or sent to other organizations) to establish the agent and/or brokerage relationship with accounts having been populated, i.e., funded, as desired by the new client 14, without any human intervention, possibly for many embodiments, other than approval, by the applicant for at least some embodiments.

Some embodiments may have a human operator 24 review at least some of the information provided by a potential client 14 to make sure the flow chart/decision matrix is being properly executed, i.e., fictitious persons are not assigned accounts, if possible, or other issues addressed, and/or stop efforts at perpetuating a fraud on the company or applicant.

In addition to brokerage accounts, insurance needs, banking needs, legal needs, or other goods/service related industries may benefit from using the methodology taught herein.

For purposes of clear support in the specification for every word of the claim language, at least some embodiments provide:

An automated onboarding method comprising the steps of:
(a) One of completing and sending a form 12 for an account of a prospective client 14 through the world wide web 18 to a computer 20 working on behalf of a company;
(b) After (a), the computer 20 automatedly extracting information from the form 12, without human assistance, to populate an account of the prospective client 12 of a customer relations management (CRM) account software with at least some of the information and adding one of a customer identifier 26 selected from the group of a customer number and an account number to the account;
(c) after (b), the computer automatedly populating, with at least some of the information based on a decision algorithm of the company, at least one document 22 selected from the group of:
   (i) a funding form selected from one of a transfer form from a third party company and a funding request from the third party company;
   (ii) an engagement agreement between the prospective client and the company; and
   (iii) an account application form to generate a specific account at the company;
(d) after (c), the computer automatedly sending the at least one document 22 to the prospective client 14 for signature through the world wide web 18;
(e) the prospective customer 14 signing the at least one document 22 and sending back through the world wide web 18 to the computer 20 of the company;
(f) the computer 20 of the company receiving the signed document and if the signed form is the funding form of step (c)(i):
   (i) the computer automatedly sending the signed form to the third party company 28 including the customer identifier of the prospective account, without human intervention; and
   (ii) upon receipt of assets from the third party 28, the CRM software being advised of the receipt to activate the account as an active customer account of an active customer 14 and advising a human operator 24 at the company to at least interact with the active customer having successfully automatedly onboarded the active customer account, such as through the CRM software, email, text, etc.

For at least some embodiments, the form of step (a) is a digital form 12. For at least some embodiments, the digital form 12 of step 2 may have reciprocal coding assisting the potential customer by autofilling at least some information on the form 12 based on information provided by the potential customer 14 on the form 12. For some embodiments, the form 12 may be built on a FormRouter™ platform. For at least some embodiments, the CRM software is Salesforce. For at least some embodiments, FormRouter creates the customer identifier 26 of step (b) provided in a .pdf format and recognized by Salesforce. For at least some embodiments, at least one document 22 is generated through a digital signing software application pulling at least some of the information provided by the potential customer 14 onto the document 22, wherein the document 22 has a pre-approved format at least approved by the company. For at least some embodiments, the digital signing software application is Docusign™ and/or wherein in step (e) the potential customer 14 electronically signs the at least one document.

For at least some embodiments, after step (b) a human operator 24 verifies the likely legitimacy of the prospective client 14 and initiates step (c), while in other embodiments, step (c) automatedly occurs following step (b) without human interaction. Additionally, for at least some embodiments, after step (e) a human operator 24 verifies the likely legitimacy of the prospective client account before onboarding the customer account, while in other embodiments, step (f) automatedly occurs following step (e) without human interaction.

For some embodiments, in step (c), the engagement letter and the funding form are sent to the prospective client 14 as the at least one document 22, and upon receipt of the signed engagement letter and the assets, the onboarding process is complete in step (f)(ii). For some embodiments, at least all three documents 22, the funding form, the engagement agreement, and an account application form are provided. For other embodiments, the engagement letter and account application form are provided.

Numerous alterations of the structure herein disclosed will suggest themselves to those skilled in the art. However, it is to be understood that the present disclosure relates to the preferred embodiment of the invention which is for purposes of illustration only and not to be construed as a limitation of the invention. All such modifications which do not depart from the spirit of the invention are intended to be included within the scope of the appended claims.

Having set forth the nature of the invention, what is claimed herein is:

1. An automated onboarding method comprising the steps of:
(a) One of completing and sending a form for a prospective client account through the world wide web to a computer working on behalf of a company;
(b) after (a), the computer automatedly extracting information from the form, without human assistance, to populate an account of the prospective client of a customer relations management (CRM) account software with at least some of the information and adding one of a customer identifier selected from the group of a customer number and an account number to the account;
(c) after (b), the computer automatedly populating, with at least some of the information based on a decision algorithm of the company, at least one document selected from the group of:
(i) a funding form selected from one of a transfer form from a third party company and a funding request from the third party company;
(ii) an engagement agreement between the prospective client and the company; and
(iii) an account application form to generate a specific account at the company;
(d) after (c), the computer automatedly sending the at least one document to the prospective client for signature through the world wide web;
(e) the prospective customer signing the at least one document and sending back through the world wide web to the computer of the company;
(f) the computer of the company receiving the signed document and if the signed form is the funding form of step (c)(i):
(i) the computer automatedly sending the signed form to the third party company including the customer identifier of the prospective account, without human intervention; and
(ii) upon receipt of assets from the third party, the CRM software being advised of the receipt to activate the account as an active customer account of an active customer and advising a human operator at the company to at least interact with the active customer having successfully automatedly onboarded the active customer account.

2. The method of claim 1 wherein the form of step (a) is a digital form.

3. The method of claim 2 wherein the digital form of step 2 has reciprocal coding assisting the potential customer by autofilling at least some information on the form based on information provided by the potential customer on the form.

4. The method of claim 1 wherein the form is built on a FormRouter™ platform.

5. The method of claim 1 wherein the CRM software is Salesforce.

6. The method of claim 5 wherein the form is built on a FormRouter™ platform and Salesforce login credentials connect the FormRouter platform to Salesforce, wherein FormRouter creates the customer identifier of step (b) provided in a .pdf format and recognized by Salesforce.

7. The method of claim 1 wherein the at least one document is generated through a digital signing software application pulling at least some of the information provided by the potential customer onto the document, wherein the document has a pre-approved format at least approved by the company.

8. The method of claim 7 wherein the digital signing software application is Docusign™.

9. The method of claim 1 wherein after step (b) a human operator verifies the likely legitimacy of the prospective client and initiates step (c).

10. The method of claim 1 wherein step (c) automatedly occurs following step (b) without human interaction.

11. The method of claim 1 wherein after step (e) a human operator verifies the likely legitimacy of the prospective client account before onboarding the customer account.

12. The method of claim 1 wherein step (f) automatedly occurs following step (e) without human interaction.

13. The method of claim 1 wherein in step e the potential customer electronically signs the at least one document.

14. The method of claim 1 wherein in step (c), the engagement letter and the funding form are sent to the prospective client as the at least one form, and upon receipt of the signed engagement letter and the assets, the onboarding process is complete in step (f)(ii).

15. The method of claim 1 wherein in step (c), the account application form and funding form are sent to the prospective client as the at least one form, and upon receipt of the signed engagement letter and the assets, the onboarding process is complete in step (f)(ii).

16. An automated onboarding method comprising the steps of:
(a) One of completing and sending a form for a prospective client account through the world wide web to a computer working on behalf of a company;
(b) after (a), the computer automatedly extracting information from the form, without human assistance, to populate an account of the prospective client of a customer relations management (CRM) account software with at least some of the information and adding one of a customer identifier selected from the group of a customer number and an account number to the account;
(c) after (b), the computer automatedly populating, with at least some of the information based on a decision algorithm of the company, at least one document selected from the group of:
(i) a funding form selected from one of a transfer form from a third party company and a funding request from the third party company;
(ii) an engagement agreement between the prospective client and the company; and
(iii) an account application form to generate a specific account at the company;
(d) after (c), the computer automatedly sending the at least one document to the prospective client for signature through the world wide web;
(e) the prospective customer signing the at least one document and sending back through the world wide web to the computer of the company; and
(f) the computer of the company receiving the signed document and if the signed form is the engagement agreement of step (c)(ii), the CRM software being advised of the receipt to activate the account as an active customer account of an active customer and advising a human operator at the company to at least interact with the active customer having successfully automatedly onboarded the active customer account.
